(19) United States
(12) Patent Application Publication
(10) Pub. No.: US 2005/0228837 A1
(43) Pub. Date: Oct. 13, 2005

(54) Approximate number calculator

(76) Inventors: Paul Marostica, Thunder Bay (CA); Bob Chomycz, Thunder Bay (CA)

Correspondence Address: Ryan W. Dupuis;Ade & Company, 1700-360 Main Street, Winnipeg, MB, R3C 3Z3, CA

(21) Appl. No.: 11/101,521

(22) Filed: Apr. 8, 2005

Related U.S. Application Data
(60) Provisional application No. 60/560,030, filed on Apr. 8, 2004.

(51) Int. Cl. G06F 13/00

(52) U.S. Cl. 708/160

(57) ABSTRACT

A calculator arranged as a program for a computer or as a stand alone device is arranged so that the processor, input and display are arranged to receive input of values and symbols, and to display using values and symbols, a plurality of approximate and exact numbers including for each such number certain values which determine that number, and to carry out calculations using the plurality of approximate and exact numbers to generate resultant approximate and exact numbers which are each determined by certain resultant values which are determined directly by the calculation, without necessarily applying any simplifying rules (ex. accuracy or precision rules).

This invention relates to an approximate number calculator.

### BACKGROUND OF THE INVENTION

An exact number is one value, which is either defined or counted or is the resultant of a calculation involving only defined and/or counted numbers. An exact number is one value: an exact value.

e.g. π as in, π is defined as exactly the quotient of any circle's circumference divided by its diameter.

e.g. I counted exactly 3 cars.

Each of the two above examples mentions one independent exact value, which completely determines one exact number. In the first example, the one independent exact value π completely determines the one exact number π. In the second example, the one independent exact value 3, of cars, completely determines the one exact number 3, of cars.

An approximate number is a continuous range of possible values, which is either measured or is the resultant of a calculation involving at least one measured number.

An approximate number is commonly referred to using some combination of values out of the following six values: an approximate value, a maximum value, a minimum value, a + (additive) variability value, a − (subtractive) variability value, and a total variability value. The +variability value and the −variability value are both always positive. The following three formulas relate the above six values out of any one approximate number:
maximum value=(approximate value+(+variability value))
minimum value=(approximate value−(−variability value))
total variability value=(+variability value)+(−variability value))

e.g. I measured somewhere between 9.5 and 10.5 mm, so arbitrarily say 10 mm.

e.g. The device indicated about 10 mm, plus or minus 0.5 mm.

e.g. I estimate approximately 10 mm, give or take half a mm.

Each of the above examples mentions three mutually independent values, in units of mm, and intentionally, each of the above examples completely determines the same one approximate number, in units of mm. The most commonly used expression for the above one approximate number, in mm, determined in each of the above examples, would likely be (10+/−0.5). This expression is composed of this one approximate number's arbitrary approximate value 10, and its related +variability value 0.5, and − variability value 0.5. By substituting these three known mutually independent values into the above formulas, this approximate number's remaining three related dependent values can be determined as the approximate number's fixed maximum value 10.5, its fixed minimum value 9.5 and its fixed total variability value 1.0.

### SUMMARY OF THE INVENTION

It is one object of the invention to provide an improved calculator.

According to one aspect of the invention there is provided an apparatus comprising:
a processor;
an input element which is operable by a user to input numerical values and the symbols into the processor;
a display operated by the processor for displaying the numerical values and the symbols;
wherein the processor is programmed to receive input of the values and the symbols, and to display using the values and the symbols, a plurality of approximate numbers including for each approximate number, certain values which determine that approximate number;
and wherein the processor is programmed to carry out calculations using the plurality of approximate numbers to generate resultant numbers which are each determined by resultant values which are determined by the calculation.

Preferably the processor is programmed to correctly determine the resultant numbers by mathematically operating directly upon the input approximate numbers, not by estimation using rules for estimating resultant accuracy or precision. Accordingly the resultant numbers may be determined without necessarily applying any accuracy or precision simplifying rules.

Preferably the processor is programmed to input and display approximate numbers each composed of up to six values, consisting of an approximate (or estimated) value, a maximum value (or tolerance), a minimum value (or tolerance), an additive variability value (or additive or positive or upper variability or variance or variation or deviation or uncertainty or error value), a subtractive variability value (or subtractive or negative or lower variability or variance or variation or deviation or uncertainty or error value), and a total variability (or variance or variation or deviation or uncertainty or error value).

Preferably the processor is programmed to receive input of the values and symbols, and to display using the values and symbols, a plurality of approximate and exact numbers including for each number certain values which determine that number.

Preferably the processor is programmed to carry out calculations using both the approximate numbers and the exact numbers to correctly generate the resultant numbers and to determine the resultant numbers by mathematically operating directly upon the input approximate numbers and the exact number, not by estimation using rules for estimating resultant accuracy or precision. Preferably the processor is programmed to input and display approximate and exact numbers each composed of up to the above-mentioned six values.

Preferably wherein the processor is programmed to input and display exact numbers each composed of one value. Preferably the processor is programmed to carry out calculations using the plurality of exact numbers to determine the resultant numbers by mathematically operating directly upon the input exact numbers.

Preferably the processor, the input element and the display are arranged to incorporate two new, more graphically correct approximate symbols: [symbol] and |, to replace the commonly used approximate symbols: [symbol] and [symbol] (overbar).

Preferably the processor, the input element and the display are arranged to incorporate a new, graphically correct exact symbol:

[symbol]

Preferably the processor, the input element and the display are arranged such that each number's value(s) is symbolically represented, where [symbol] represents each up-to-six value number and [symbol] represents each one value number.

Preferably the processor, the input element and the display are arranged such that each value of each number is displayed graphically arranged adjacent to the part of the symbol representing it.

Preferably the processor, the input element and the display are arranged such that no more than three mutually independent input values are required to determine all values of each up-to-six value number.

Preferably the processor, the input element and the display are arranged such that no more than two mutually independent input values are required to determine all values of each up-to-six value number when the numbers have equal additive and subtractive variability values.

Preferably the processor, the input element and the display are arranged such that only one input value is required to determine all values of an up-to-six value number by selecting input option additive and subtractive variability values +/−0 for exact numbers, or input option additive and subtractive variability values +/−0.5 of the decimal place determined by the positioning of a symbol in the approximate value's real part.

Preferably the processor, the input element and the display are arranged such that the options Parts: Real, and Parts: Real×10 Exp, replace a standard calculator's Mode: Normal, and [EE] (or [EXP]) buttons.

Preferably the processor, the input element and the display are arranged so as to display values in visually proper real, or real×10^{exponent}, mathematical notation.

Preferably the processor, the input element and the display are arranged so as to provide an automatic pasting option which can cause an editable input value(s) or character(s) to be automatically pasted whenever a new number's first character is typed.

Preferably the processor, the input element and the display are arranged to determine and convert a number among simplifying options including rounding or truncating, either fixed or with placeholding zeros only, either by typing the desired number of digits, or by typing the integer exponent of base 10 of a desired decimal place, or by positioning a symbol immediately right of a desired digit or decimal place.

Preferably the processor, the input element and the display are arranged such that when first positioned within a number's value's real part, an approximate cut-off symbol automatically self-positions at 0 digits to aid in counting digits if simplifying by digits, or the symbol automatically self-positions immediately right of the desired decimal place indicating the desired decimal place if simplifying by decimal place.

Preferably the processor, the input element and the display are arranged such that a number can be determined and converted among a plurality of mathematical notations, including scientific, engineering and real×(a desired power of 10).

Preferably the processor, the input element and the display are arranged such that a number can be determined and converted among having an approximate value determined directly by calculation, or having an approximate value centered between minimum and maximum values of the number.

Preferably the processor, the input element and the display are arranged so as to determine and convert a number among a plurality of combinations of input and output values including values, (values/|approximate value|) and ((values/|approximate value|)×100%).

An approximate number calculator is a calculator that can correctly represent and do mathematical calculations upon approximate numbers, not just represent and do mathematical calculations upon individual values of approximate numbers, and do so without having to use simplifying rules, ex. accuracy or precision rules, which only roughly determine a resultant approximate number's values.

Though the approximate number calculator described herein directly represents approximate and exact numbers as groups of only five related values, and does mathematical calculations directly upon those groups, a simple and efficient follow-up calculation on this calculator can then immediately determine any approximate number's sixth value, its total variability value, as desired.

Our current approximate number calculator version can, beginning from either three, two or one typed value(s) in any one of a number of equivalent representations, determine all five values of both approximate and exact numbers simply and efficiently and can then display those five determined values of each approximate and exact number simply and efficiently in a number of other equivalent representations.

Though the number calculator herein is only described using arithmetic mathematical operations, including adding, subtracting, multiplying and dividing, with a plurality of five value approximate and exact numbers together in a calculation or with one value exact numbers together in a calculation, other mathematical operations may readily be added with additional programming.

The approximate number calculator could be programmed for use with any type of computer or could be developed into various types of handheld devices including calculators and the like. The calculator could also be programmed to link to another device(s) for transmitting approximate and exact numbers.

### DETAILED DESCRIPTION

Physical Theory

Quantities

A quantity of an object is some number of some unit(s). More mathematically, a quantity of an object is the product of a number factor multiplied by a unit(s) factor.

e.g. 7 m/s is a quantity where 7 is the number and m/s are the units.

7 m/s is a quantity which is the product of a number factor 7 multiplied by a units factor m/s.

Exact Quantities

An exact quantity of an object is a quantity of an object determined by definition or counting, or as the resultant of a calculation involving only defined and/or counted quantities. An exact quantity of an object is specifiable to being one quantity only.

Approximate Quantities

Excepting counting devices, no device exists which can exactly measure any quantity of any object.

A hypothetical exact measuring device might require an infinite number of rulings, with all rulings having exactly equal infinitesimal widths, and all adjacent rulings separated by exactly equal infinitesimal distances, with those widths and distances always remaining constant, independent of the exact measuring device's temperature, position, time, etc. Also, because the quantity of any object being measured can vary with temperature, position, time, etc., a user would have to be able to align the exact rulings on the hypothetical exact measuring device exactly to the quantity of the object being measured for an infinitesimal amount of time and thereby determine the exact quantity of that object at an exact time by exact measurement.

An actual measuring device instead has only a finite number of rulings, with all rulings having only approximately equal finite widths, and all adjacent rulings separated by only approximately equal finite distances, with those widths and distances remaining, at best, only approximately constant, possibly varying with the measuring device's temperature, position, time, etc. Also, because the quantity of any object being measured can vary with temperature, position, time, etc., a user will have to align the approximate rulings on the measuring device to the rulings nearest to the quantity of the object being measured for a finite amount of time and thereby determine only the approximate quantity of that object at an approximate time by approximate measurement.

Thus, an approximate quantity of an object is a quantity of an object determined by measurement, or as the resultant of a calculation involving at least one quantity of an object which was determined by measurement. An approximate quantity of an object is generally specifiable only to being a continuous range of possible quantities from some minimum possible quantity to some maximum possible quantity.

Mathematical Theory

Numbers

A number is the numeric factor out of a quantity.

e.g. 7 is the number, and m/s are the units, out of the quantity 7 m/s.

7 is the number factor which multiplies m/s the unit(s) factor to equal the product quantity 7 m/s.

For use on our approximate number calculator, we will be concerned only with the number, or numeric factor, out of any quantity.

e.g. In the quantity 7 m/s, we will concern ourselves only with that quantity's numeric factor, the number 7.

Values

A value is a sub-number, such that any number is composed of one or more values.

A dependent value is a value which is already determined by another known value(s).

An independent value is a value which is not already determined by another known value(s).

Exact Numbers

An exact number is the number factor out of an exact quantity, and is one value, which is either defined or counted or is the resultant of a calculation involving only defined and/or counted numbers.

An exact number is one value: an exact value.

e.g. π is defined as exactly the quotient of any circle's circumference divided by its diameter.

e.g. I counted exactly 3 cars.

Each of the two above examples mentions one independent exact value, which completely determines one exact number. In the first example, the one independent exact value π completely determines the one exact number π. In the second example, the one independent exact value 3, of cars, completely determines the one exact number 3, of cars.

Approximate Numbers

An approximate number is the number factor out of an approximate quantity, and is generally a continuous range of possible values, which is either measured or is the resultant of a calculation involving at least one measured number.

An approximate number is most commonly specified by referring to some combination of values out of the following five values: an approximate value, a maximum value, a minimum value, a +variability value, and a −variability value.

The following two formulas relate the above five values out of any one approximate number:
maximum value=(approximate value+(+variability value))
minimum value=(approximate value−(−variability value))

Other formulas relating the values of any one approximate number can be derived from the above two formulas:
approximate value=(maximum value−(+variability value))
approximate value=(minimum value+(−variability value))
+variability value=(maximum value−approximate value)
−variability value=(approximate value−minimum value)

In any approximate number, only the maximum and minimum values are fixed. An approximate number's approximate value, if mentioned, can be arbitrarily chosen to be any one possible value from the approximate number's minimum value to its maximum value. An approximate number's approximate value is commonly used as a single arbitrary reference value for use as a quick, simplified reference to that approximate number. Knowing an approximate number's minimum and maximum values and then arbitrarily choosing an approximate value as any one value from the approximate number's minimum value to its maximum value automatically determines the approximate number's +/−variability values according to the last two above formulas.

In any approximate number, certain of its above five values may be considered to be independent, with the remaining values being considered to be dependent in that they can be determined from the independent values. E.g. If an approximate number's approximate and +/−variability values are initially known, then its maximum and minimum values can be determined from those initially known values using the first two above formulas. In this example, then, the approximate and +/−variability values are considered to be the independent values from which the remaining dependent maximum and minimum values can be determined. Which of an approximate number's values are independent and which are dependent, depends on which values were used to determine which other values.

Mutually independent values are values which are all independent of one another. Any three known mutually independent values of an approximate number can be used to determine that approximate number's remaining two dependent values by substituting the known mutually independent values into one or more of the above formulas and solving for the dependent values. Because any three known mutually independent values of an approximate number can be used to determine that approximate number's remaining two dependent values, an approximate number can be efficiently represented by any expression which contains any three mutually independent values from the above five mentioned values, such that those three mutually independent values can then be used to completely determine the approximate number by determining its remaining two dependent values.

e.g. I measured somewhere between 9.5 and 10.5 mm, so arbitrarily say 10 mm.

e.g. The device indicated about 10 mm, plus or minus 0.5 mm.

e.g. I estimate approximately 10 mm, give or take half a mm.

Each of the above examples mentions three mutually independent values, in units of mm, and intentionally, each of the above examples completely determines the same one approximate number, in units of mm. The most commonly used expression for the one approximate number, in mm, determined in each of the above examples, would likely be (10+/−0.5). This expression is composed of this one approximate number's arbitrary approximate value 10, and its related +variability value 0.5, and −variability value 0.5. By substituting these three known mutually independent values into the above formulas, which relate the values of any one approximate number, these three known mutually independent values can be used to determine this approximate number's remaining two related dependent values, which are its fixed maximum value 10.5, and its fixed minimum value 9.5, thereby determining all five of its above-mentioned values.

An approximate number's approximate value can be, but need not be, centered halfway between its minimum and maximum values. Thus an approximate number's +/−variability values need not be equal. An approximate number is generally specifiable only to being a range of possible values. An approximate number's approximate value, if mentioned, can be any one arbitrarily chosen value from that range.

It therefore follows that any two approximate numbers having equal minimum and maximum values are actually equal, even if their mentioned approximate values, which are arbitrary, are not equal. Equal approximate numbers will have two fixed values which are equal: their minimum and maximum values; and three arbitrary related values which may or may not be equal: their approximate and +/−variability values.

Any resultant approximate number's arbitrary approximate value may be either calculated directly from the arbitrary approximate values of that calculation's approximate numbers, or else may be chosen arbitrarily to be any value which is no less than the resultant approximate number's calculated fixed minimum value and no more than its calculated fixed maximum value.

Simplifying

To complete even the simplest approximate number calculation, a user of a standard calculator is required to laboriously do, store and relate the results of multiple mathematical operations among the individual values of the approximate numbers being mathematically operated upon.

To save time and effort in doing approximate number calculations, certain arbitrary yet practical simplifying rules have been used for quickly, but only very roughly, determining a resultant approximate number's values. These simplifying rules, known as accuracy and precision rules, are particularly useful in reducing the time and effort involved in completing rough approximate number calculations. Accuracy and precision rules each assume that a resultant approximate number is to be arbitrarily roughly simplified to another approximate number which possesses an approximate value having its last digit in some finite decimal place, +/−variability values that are 0.5 of that decimal place, and therefore the approximate value is centered halfway between the minimum and a maximum values with the minimum and maximum values each ending with a 5 in the decimal place after the last decimal place of the approximate value.

The above arbitrary simplifying accuracy and precision rules assumptions are practical in only certain circumstances. It should be understood that these simplifying accuracy and precision rules only very roughly determine a resultant approximate number, and that the unsimplified determination of a resultant approximate number's values is accomplished without any such simplifying assumptions and most often yields a resultant approximate number possessing values which are very different from those mentioned above.

Our calculator determines all five values of any resultant approximate number, each to 28 digits, with no such simplifying assumptions whatsoever. Therefore, our calculator completely eliminates the need for using simplifying accuracy or precision rules to quickly, roughly determine a resultant approximate number's values. On our calculator a user will seldom calculate an unsimplified resultant approximate number having +/−variability values equaling 0.5 of some decimal place.

Given that our calculator calculates a resultant approximate number's five values, each to 28 digits, completely eliminating the need for using simplifying accuracy and precision rules, there still remains another simplifying problem. Our calculator's users most often won't need or want to use all 28 digits of a value, particularly so when there are five 28 digit values per number. Thus, users of our calculator will want to be able to simplify an approximate number's five 28 digit values. On our calculator, consistently simplifying approximate numbers, each composed of five 28 digit values, requires simultaneously simplifying all five values of each approximate number in the same way. Fortunately, on our calculator, this is done automatically, determined by the simplifying option selected by the user. It is therefore important for each user to understand simplifying.

Simplifying means eliminating undesired detail. Truncating or rounding a quantity, number or value implies truncating or rounding its value(s). Truncating or rounding a quantity, number or value may simplify it.

Truncating means cutting off.

Rounding means making round, meaning ending in a 0 or 0's.

Truncating or rounding a quantity, number or value means truncating or rounding the value(s) of that quantity, number or value.

Both truncating and rounding a value commonly make that value more round. Typically, values are truncated or rounded to simplify them, to eliminate undesired detail.

Any value may be truncated and/or rounded either to any arbitrary smallest decimal place, or to any arbitrary number of digits. Both truncating and rounding a value can involve inserting either only some number of necessary placeholding 0's, or else both some number of necessary placeholding 0's and some number of possible further O's to have the value end at some fixed arbitrary decimal place or contain some fixed arbitrary number of digits.

Truncating

A value truncated to some arbitrary smallest decimal place is the value determined first by cutting off the digits in all of that value's decimal places which are smaller than that arbitrary smallest decimal place. If no digit remains after this cutting off, then a 0 should be inserted into the arbitrary smallest decimal place. Next, a 0 should be inserted to replace each cut-off digit necessary, as a decimal place placeholder, for determining the decimal place(s) of the remaining digit(s). If the value was to be truncated fixed to the arbitrary smallest decimal place, and the truncated value's current smallest decimal place is still larger than the fixed arbitrary smallest decimal place, a 0 may then be inserted into each decimal place which is smaller than the current smallest decimal place and greater than or equal to the fixed arbitrary smallest decimal place. The truncated value's arbitrary smallest decimal place, if it contains a digit, should then somehow be indicated.

A value truncated to some arbitrary number of digits is the value determined first by cutting off the digits in all of that value's decimal places which are smaller than the smallest decimal place determined by the arbitrary number of digits, counted beginning with the digit in the largest decimal place, from large decimal place to small. Next, a 0 should be inserted to replace each cut-off digit necessary, as a decimal place placeholder, for determining the decimal place(s) of the remaining digit(s). If the value was to be truncated fixed to the arbitrary number of digits, and the truncated value's current number of digits is still less than the fixed arbitrary number of digits, then beginning with the next decimal place smaller than the current smallest decimal place, a 0 may be inserted into each progressively smaller decimal place until the value has that fixed arbitrary number of digits. The truncated value's decimal place which would contain the last of the arbitrary number of digits, if it contains a digit, should then somehow be indicated.

Rounding

A value rounded to some arbitrary smallest decimal place is either one of two values. It is either that value truncated to that arbitrary smallest decimal place, or else is the value which is the sum of that value truncated to that arbitrary smallest decimal place added to a separate value having only the digit 1 in that arbitrary smallest decimal place, whichever of the two would be closest to the original value.

A value rounded to some arbitrary number of digits is either one of two values. It is either that value truncated to that arbitrary number of digits, or else is the value which is the sum of that value truncated to that arbitrary number of digits added to a separate value having only the digit 1 in the decimal place of the last of that arbitrary number of digits, whichever of the two would be closest to the original value.

Approximate Number Calculator

In the following square brackets [ ] denote a calculator button.

Unique Features

Represent and calculate directly with approximate numbers, not just individual values of approximate numbers.

Completely determine resultant approximate numbers by mathematically operating directly upon input approximate numbers, without any simplifying of resultant using accuracy or precision rules.

Approximate and exact numbers each composed of five values, not just the typical three values.

Two new, more graphically correct approximate symbols: [symbol] and | (=approximate symbol cut-off cursor), to replace the commonly used approximate symbols: [symbol] and [symbol] (=overbar).

Each number's value(s) symbolically graphically represented: [symbol] represents each one value number as it might appear on a graph as one exact value point; [symbol] represents each five value number as it might appear on a graph, with the top, middle and bottom black squares respectively representing its maximum, approximate and minimum value points, the upper gray rectangle representing its +variability value, and the lower gray rectangle representing its −variability value.

Each value of each number displayed graphically arranged adjacent to the portion of the symbol graphically representing it.

For each number in any calculation optionally display: all five values, or approximate and +/−variability values, or minimum, approximate and maximum values, or just minimum and maximum values.

Values displayed in visually proper real, and real×10 exponent mathematical notations.

No more than three input values required to determine all values of each five value number.

No more than two input values required to determine all values of each five value number having its approximate value centered halfway between its minimum and maximum values (implying equal +/−variability values).

Only one input value, the approximate value, required to determine all values of the most commonly used five value numbers: type only the approximate value and use input option +/−variability values=0 for each exact number; or type only the approximate value and use input option +/−variability values=0.5 of the approximate value's selected decimal place for each approximate number having its approximate value centered and its +/−variability values equal 0.5 of the decimal place determined by the user-positioned approximate symbol cut-off cursor | when positioned in the approximate value's real part.

Enter button [E]= [symbol] or [symbol] and any mathematical operator button e.g. [+], each automatically cause determination of the last input number's remaining dependent values, if any, and determination of all values in proper mathematical notation.

Parts: Real, and Parts: Real×10 Exp options replace standard calculator's Mode: Normal, and [EE] (or [EXP]) button.

Optionally automatically paste a desired editable input value(s) and/or character(s) whenever a new number's first character is typed.

Optionally round or truncate all of any number's values: to a desired number of digits by typing that desired number of digits; or to a desired decimal place, either by typing the integer exponent of base 10 of that desired decimal place or by positioning the approximate symbol cut-off cursor | immediately right of that desired decimal place.

When first positioned within an entered number's value's real part, the approximate symbol cut-off cursor | automatically self-positions. If simplifying was by number of digits | self-positions to cut off at 0 digits to aid in counting digits, or if simplifying was by decimal place | self-positions to cut off immediately right of the simplifying decimal place, indicating the simplifying decimal place.

Optionally convert output power of 10 mathematical notations among scientific, engineering, and any desired power of 10.

Optionally determine approximate values independently, or centered halfway between minimum and maximum values.

Optionally convert various combinations of input and output values among values, (values/|approximate value|) and ((values/|approximate value|)×100%).

General Description

An approximate number calculator is a calculator that can represent and do mathematical calculations directly upon approximate numbers, not just represent and do mathematical calculations upon individual values of approximate numbers, and can do so without resorting to simplifying, for example by using accuracy or precision rules.

Our calculator can represent approximate numbers as groups of five related values and do arithmetic calculations directly upon those groups.

Our calculator can also represent exact numbers as groups of five related values so that arithmetic calculations can be done directly upon both approximate and exact numbers together in any calculation.

From either three, two or one typed value(s) per number, in any one of a number of equivalent representations, our calculator can determine all five values of both approximate and exact numbers very simply and efficiently, and can then represent the five values of each approximate and exact number very simply and efficiently in a number of equivalent representations, all while adding, subtracting, multiplying and/or dividing with any combination of approximate and exact numbers together in any calculation.

Uniqueness and Improvements Compared to Other Calculators

Standard calculators are limited to doing calculations only upon exact numbers. Our calculator can do calculations either upon exact numbers, or upon both approximate and exact numbers, depending on the Numbers: Option selected.

As on a standard calculator, on our calculator when Numbers: Exact is selected, exact numbers are represented by the symbol [symbol] which represents each one value number as it might appear on a graph. The one black square represents the one value number's one Exact Value point.

e.g. The exact number, 3 once typed and entered, can be represented on our calculator as the one value number:

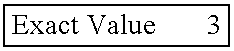

On our calculator, when Numbers: Approximate is selected, both approximate and exact numbers are each represented by the symbol [symbol] which represents each five value number as it might appear on a graph. The top, middle and bottom black squares respectively represent the five value number's Maximum Value, Approximate Value and Minimum Value points. The upper gray rectangle represents the five value number's +Variability Value, which is its largest possible additive error when using its Approximate Value to represent it, and which equals the difference between its Maximum Value and its Approximate Value. The lower gray rectangle represents the five value number's −Variability Value, which is its largest possible subtractive error when using its Approximate Value to represent it, and which equals the difference between its Minimum Value and its Approximate Value.

e.g. The approximate number (10+/−0.5), once typed and entered, can be represented on our calculator as the five value number:

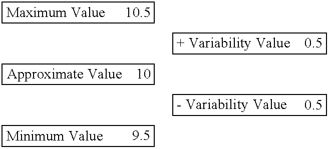

e.g. The exact number 3, once typed and entered, can be represented on our calculator as the five value number:

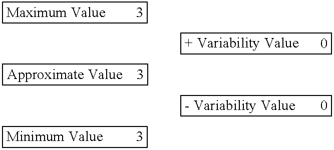

Standard calculators can represent and do calculations only upon individual values of approximate numbers, so that representing and doing even the simplest approximate number calculation on a standard calculator requires a user to laboriously do, store and relate the results of multiple mathematical operations among the approximate numbers' individual values. Our calculator, when Numbers: Approximate is selected, can represent both approximate and exact numbers, each as a group of five related values, and do mathematical calculations directly upon those groups.

Our calculator, when Numbers: Approximate is selected, mathematically represents and operates upon five value numbers as simply as a standard calculator mathematically represents and operates upon one value numbers. The only effective difference is that on our calculator, when Numbers: Approximate is selected, a user types one, two or three values per number, instead of just one, before typing a mathematical operator. Our calculator does the rest. This is accomplished by our having programmed our calculator to automatically internally do, store and relate the results of the multiple mathematical operations among the approximate numbers' individual values, freeing the user from all that previously unavoidable time-consuming labor, and enabling them to concentrate on results.

Steps Involved to Obtain a Resultant

As on a standard calculator, on our calculator when Numbers: Exact is selected, only one value need be typed to completely determine an exact number's one value. Optionally typing enter [E] (= [symbol] when Numbers: Exact is selected) causes the calculator to convert the number's one value to proper mathematical notation, completely determining it and displaying its one value in proper mathematical notation as a single one value number. Then typing a mathematical operator, e.g. [+], automatically causes the calculator to enter the prior value (so that [E] need not have been typed), and readies the entered number's one value to be operated upon as a single one value number. Another number's one value can then be typed (again optionally followed by typing [E]). If the calculation happens to involve only the one mathematical operation, e.g. adding those two numbers, then typing [=] causes the calculator to determine and display the one value resultant number in proper mathematical notation.

On our calculator when Numbers: Approximate is selected, only one, two or three of a number's mutually independent values need be typed to completely determine that number's five values. Optionally typing enter [E] (= [symbol] when Numbers: Approximate is selected) causes our calculator to automatically convert those values to proper mathematical notation, determine the number's remaining four, three or two dependent values in proper mathematical notation, and then display its five values together in proper mathematical notation, as a single five value number. Then typing a mathematical operator, e.g. [+], automatically causes our calculator to enter the prior values (so that [E] need not have been typed), and readies the entered number's five values to be operated upon together as a single five value number. Another number's one, two or three mutually independent values can then be typed (again optionally followed by typing [E]). If the calculation happens to involve only the one mathematical operation, e.g. adding those two numbers, then typing [=] causes our calculator to determine and display the five value resultant number in proper mathematical notation.

The above describes only the steps involved to obtain the resultant of a simple calculation on our calculator. Our calculator has numerous options which enable a user to calculate while both typing input values in any one of a number of equivalent representations, and displaying output values in a number of equivalent representations.

Options

The following is a hierarchy of the non-standard menu items, buttons, options, textboxes and checkboxes, collectively referred to as options, currently available on our calculator.

Numbers:

Exact: Enables representation of and calculation upon one value exact numbers.

Approximate: Enables representation of and calculation upon five value approximate and exact numbers.

Values:

Show Options: Shows various Unentered Values: Options (=options for values being typed), and Entered Values: Options (=options for the value(s) in a number which has already been completely determined).

Hide Options: Hides various Unentered Values: Options (=options for values being typed), and Entered Values: Options (=options for the value(s) in a number which has already been completely determined).

Parts:

Real: Causes each value to have one editable part, a real part, for real notation.

Real×10 Exp: Causes each value to have 2 editable parts, a real part, and an integer exponent of base 10 part, with a non-editable ×10 in between, for power of 10 notations.

Customize:

Value Names:

Dark: Causes the names of each number's values to be colored dark for visibility.

Light: Causes the names of each number's values to be colored light for reduced visibility, effectively enhancing the values' visibility.

Values Visible: When Numbers: Approximate is Selected

All: Causes all five values of each five value number to be visible.

Approximate +/−Variability: Causes only the Approximate and +/−Variability Values of each five value number to be visible.

Minimum Approximate Maximum: Causes only the Minimum, Approximate and Maximum Values of each five value number to be visible.

Minimum Maximum: Causes only the Minimum and Maximum Values of each five value number to be visible.

Entered Color:

On: Causes the background color of all entered numbers' values' parts to be the entered number background color.

Off: Causes the background color of all entered numbers' values' parts to remain the same as the unentered number background color.

Repeatable [=]:

On: When a resultant number is displayed, causes retyping [=] to repeat the prior operation upon that resultant number.

Off: When a resultant number is displayed, causes retyping [=] to have no effect upon that resultant number.

Help:

Manual: Opens calculator user information manual.

Producer: Lists calculator product and producer contact information.

[−1 x]: (=Change Sign) Causes ⁻1 to multiply the current number part, so that it becomes ⁻ if it was ⁺, or ⁺ if it was ⁻.

[.]: (=Decimal) Causes a decimal to be inserted at the insertion point in the current number part.

[0], [1], or [9] (=Digit 0, 1, . . . , or 9) Causes the digit 0, 1, . . . , or 9 to be inserted at the insertion point in the current number part.

[CL]: (=Clear Left) Causes clearing of the character left of the insertion point in the current number part.

[E]: (= [symbol] when Numbers: Exact is selected, or = [symbol] when Numbers: Approximate is selected) When the current number is unentered, causes a redetermination of each of that number's typed mutually independent values, and causes the determination of any remaining untyped dependent values, all in proper mathematical notation subject to the Entered Values: Options selected.

[M]: (=Memory) If the current value(s) is unentered memorizes the current unentered value(s) as is, or if the current number is entered memorizes the entered number's fundamental value(s).

[PM]: (=Paste Memory) If [M] contains an unentered value(s) pastes from [M] a copy of the unentered value(s) as is, or if [M] contains an entered number pastes from [M] a copy of the fundamental value(s) of the one entered number subject to the Entered Values: Options selected.

[CM]: (=Clear Memory) Clears [M].

Unentered Values:

Auto Paste:

Off: (=Auto Paste Paste Memory Off) Deactivates automatic pasting of a copy of an unentered value(s) or value part(s) from Unentered Values: Auto Paste: [M] when a new number's first character ([−1 x], [.], or [0], [1], . . . , or [9]) is typed.

On: (=Auto Paste Paste Memory On) Activates automatic pasting of a copy of an unentered value(s) or value part(s) from Unentered Values: Auto Paste: [M] when a new number's first character ([−1 x], [.], or [0], [1], . . . , or [9]) is typed.

[M]: (=Auto Paste Memory) Memorizes the typed value(s) or value part(s) of a current unentered number, if any.

[CM]: (=Auto Paste Clear Memory) Clears Unentered Values: Auto Paste: [M].

Notation:

Real: Causes each unentered number's value(s) to be in real mathematical notation, subject to other Unentered Values: Options selected.

Real×10 Exp: Causes each unentered number's value(s) to be in (real×10^{exponent}) mathematical notation, subject to other Unentered Values: Options selected.

Lone Approximate Value Implies +/−Variability Values:

=0: When an Approximate Value only has been typed, then upon entry, automatically causes the +/−Variability Values to be 0, such that the entered number will be the five value exact number determined by those three values.

=0.5× Select Approximate Value Decimal Place: When an Approximate Value only has been typed, and the approximate symbol cut-off cursor | has been positioned in the Approximate Value's real part next to a digit, causes the selected decimal place to be the decimal place immediately left of the cursor, then upon entry, automatically causes the +/−Variability Values to be 0.5× (the product of the Approximate Value's real part's selected decimal place multiplied by the Approximate Value's power of 10, if any), such that the entered number will be the five value approximate number determined by those three values.

/|Approximate Value|:

No Values: Causes each typed unentered value(s) to automatically be a value(s) as is.

+/−Variability Values Only: Causes each typed unentered Variability Value(s) to automatically be a (value(s)/|Approximate Value|).

All Values Except Approximate Value: Causes each typed unentered value(s), except for the Approximate Value, to automatically be a (value(s)/|Approximate Value|).

%: Causes any of the above typed unentered (value(s)/|Approximate Value|) to automatically be a ((value(s)/|Approximate Value|)×100%).

Entered Values:

Simplifying:

Round: Causes each entered number's value(s), subject to the other Entered Values: Options selected, to be simplified by rounding. When the Entered Values: Simplifying: Options have not been specified the calculator automatically defaults to this option.

Truncate: Causes each entered number's value(s), subject to the other Entered Values: Options selected, to be simplified by truncation.

Digits: Causes each entered number's value(s), subject to the other Entered Values: Options selected, to be simplified to a user typed number of digits, displaying placeholding zeros only. The user first selects this option, then types the desired number of digits, then either reselects this option or selects any number value part or selects any other non-conflicting option, which causes the entered number's value(s) to be simplified to that user typed number of digits. When the Entered Values: Simplifying: Options have not been specified the calculator automatically defaults to this option, assuming 26 Digits.

None: 28 Digits: Causes each entered number's value(s), subject to other Entered Values: Options selected, to be the calculator's unsimplified 28 digit truncated value(s), displaying placeholding zeros only.

10 Decimal Place: Causes each entered number's value(s), subject to the other Entered Values: Options selected, to be simplified to a user typed fixed decimal place. The user first selects this option, then types the integer exponent of base 10 of that power of ten decimal place, then either reselects this option or selects any number value part or selects any other non-conflicting option, which causes the entered number's value(s) to be simplified to that user typed fixed decimal place.

Select Decimal Place: Causes each entered number's value(s), subject to the other Entered Values: Options selected, to be simplified to a user cursor-positioned fixed decimal place. The user first selects this option. Next the user positions the approximate symbol cut-off cursor | in any one value's real part next to a digit, causing the selected decimal place to be the decimal place immediately left of the cursor, such that the selected decimal place is the product of that value's real part's selected decimal place multiplied by its power of 10, if any. The user then reselects this option, or selects any other non-conflicting option, which causes the entered number's value(s) to be simplified to that user cursor-positioned fixed decimal place, and further causes the Entered Values: Simplifying: Option to change to Entered Values: Simplifying: 10 Decimal Place, indicating the selected fixed decimal place as a power of 10 decimal place.

Notation:

Real: Causes each entered number's value(s) to be in real notation, subject to other Entered Values: Options selected.

Scientific: Causes each entered number's value(s) to be as is, in scientific notation, subject to other Entered Values: Options selected.

Engineering Causes each entered number's value(s) to be converted to an: equal engineering notation value(s), subject to other Entered Values: Options selected.

Real×10: Causes each entered number's value(s) to be converted to an equal (real×10^{fixed exponent}) value(s), determined by a user-typed fixed exponent of base 10. The user first selects this option, then types the integer exponent of base 10 of the desired power of ten decimal place, then either reselects this option or selects any number value part or selects any other non-conflicting option, which causes the entered number's value(s) to be converted to that user typed fixed power of 10, subject to other Entered Values: Options selected.

Approximate Value:

Independent: Causes each entered number's Approximate Value to be as is, independent, subject to other Entered Values: Options selected.

Centered: Causes each entered number's Approximate Value to be redetermined to be the value halfway between the number's Minimum Value and Maximum Value, thus causing the +/−Variability Values to be equal, subject to other Entered Values: Options selected.

/|Approximate Value|:

No Values: Causes each entered number's values to be as is, subject to other Entered Values: Options selected.

+/−Variability Values Only: Causes each entered number's Variability Values to be redetermined as (values/|Approximate Value|), subject to other Entered Values: Options selected.

All Values Except Approximate Value: Causes each entered number's values, except for the Approximate Value, to be redetermined as (values/|Approximate Value|), subject to other Entered Values: Options selected.

All Values: Causes all of each entered number's values to be redetermined as (values/|Approximate Value|), subject to other Entered Values: Options selected.

%: Causes each entered number's above (values/|Approximate Value|) to be redetermined as ((values/|Approximate Value|)×100%), subject to other Entered Values: Options selected.

Input

Unentered Values: Auto Paste: On can be selected to automatically paste a copy of a typed unentered value(s) or value part(s) whenever a new number's first character ([−1 x], [.], or [0], [1], . . . , or [9]) is typed.

When Parts: Real is selected Unentered Values: Notation: Real automatically becomes the calculation's input mathematical notation, with each value having one editable part, a real part, available for typing. When Parts: Real×10 Exp is selected Unentered Values: Notation: Real×10 Exp automatically becomes the calculation's input mathematical notation, with each value having two editable parts, a real part and an integer exponent of base 10 part, available for typing.

As on a standard calculator, on our calculator when Numbers: Exact is selected: and a user types in a value, then upon entry the value is automatically determined in the currently selected mathematical notation.

On our calculator, when Numbers: Approximate is selected: and
a user types in any three mutually independent values, then upon entry the remaining two dependent values are automatically determined;
or a user types in only any two mutually independent values, then upon entry the Approximate Value is automatically centered halfway between the Minimum and Maximum Values with the +/−Variability Values automatically being equal, and the remaining three dependent values are determined accordingly;
or a user types in only one independent value, the Approximate Value, then upon entry the number is automatically determined with equal +/−Variability Values according to the selected Unentered Values: Lone Approximate Value Implies +/−Variability Values: Option, such that:
if Unentered Values: Lone Approximate Value Implies +/−Variability Values: =0 is selected, then upon entry the number is automatically assumed to be a five value exact number having +/−Variability Values=0, and then the remaining two dependent values are determined accordingly;
otherwise, if Unentered Values: Lone Approximate Value Implies +/−Variability Values: =0.5× Select Approximate Value Decimal Place is selected, then if the user has positioned the approximate symbol cut-off cursor | within the Approximate Value's real part next to a digit, which causes the selected decimal place to be the decimal place immediately left of the cursor, then upon entry the number is automatically a five value approximate number having +/−Variability Values=0.5× (the product of the Approximate Value's real part's selected decimal place multiplied by the Approximate Value's power of 10, if any), and then the remaining two dependent values are determined accordingly.

All values are automatically determined in the currently selected mathematical notation.

When Numbers: Approximate is selected, then by selecting various Unentered Values: /|Approximate Value|: Options, various values typed can be an Approximate Value, and either other values, (values/|Approximate Value|) or ((values/|Approximate Value|)×100%).

Input and Output

When Numbers: Exact is selected our calculator can do calculations upon one value exact numbers. When Numbers: Approximate is selected our calculator can do calculations upon five value exact and approximate numbers.

Our calculator has a one number memory [M], which can store any input or output exact or approximate number's fundamental value(s). [PM] pastes this stored number, and if the stored number was an entered number, displays it according to the combination of Entered Values: Options currently selected.

As already mentioned, our calculator can represent and calculate directly with exact and approximate numbers in various mathematical notations. On a standard calculator, to calculate with numbers in real notation a user selects Mode: Normal, and then to calculate with numbers in power of 10 notation as needed a user types [EE] (or [EXP] depending on the calculator). On a standard calculator, users can easily logically mistake [EE] (or [EXP]) for [x^{y}] (or [y^{x}] depending on the calculator). On our calculator, to calculate with numbers in real notation a user selects Parts: Real, or to calculate with numbers in a power of 10 notation a user selects Parts: Real×10 Exp, avoiding possibly mistaking [EE] (or [EXP]) for [x^{y}] (or [y^{x}]).

Most other hardware and software calculators display values in power of 10 notations that at best look only roughly like proper typed or handwritten mathematical notation. Standard calculators typically represent values, e.g. 2×10³, in a power of 10 notation which uses a computer notation, e.g. 2E3. Because this notation replaces the mathematically proper ×10 with an E, it is often logically mistaken by users to represent base 2 exponent 3, or 2³, instead of its intended 2×10³. Some more recent standard calculators do have a proper ×10 in place of the E, but usually not with the appropriate spacing and sizing to look like proper typed or handwritten mathematical notation. Our calculator, when Parts: Real×10 Exp is selected, displays two numerically editable parts in its representation of each value, a real part, and an integer exponent of base 10 part, with a non-editable ×10 in between, so that a value in a power of 10 notation, e.g. 2×10³, is displayed on our calculator looking like proper typed or handwritten mathematical notation as

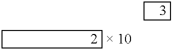

Our calculator currently offers the following input mathematical notation/output mathematical notation combinations:

$$Real / Real$$

$$Real \times 10 Exp / Scientific$$

$$Real \times 10 Exp / Engineering$$

$$•$$

$$Real \times 10 Exp / Real \times 10$$

Output

On our calculator, by selecting various pairs of Entered Values: Simplifying: Options, any entered number's value(s) can be left unsimplified, or else can be simplified by either rounding or truncating. Simplifying by either rounding or truncating can be to a user-typed number of digits, or to a decimal place which is either user-typed, or else user cursor-positioned by positioning our calculator's approximate symbol cut-off cursor|.

When Parts: Real is selected Entered Values: Notation: Real automatically becomes the calculation's output mathematical notation, with each value having one redisplayable part, a real part. When Parts: Real×10 Exp is selected, each value automatically has two redisplayable parts, a real part and an integer exponent of base 10 part. When Parts: Real×10 Exp is selected, the Entered Values: Notation: Options are Scientific,

$$\begin{matrix} & • \\ Engineering and Real \times 10. & \end{matrix}$$

The selected one of the three Entered Values: Notation: Options automatically becomes the calculation's output mathematical notation, so that any entered number's value(s) can be displayed in scientific notation, engineering notation, or in a power of 10 notation in which the user determines the power of 10 by typing its integer exponent of base 10.

On our calculator, when Numbers: Approximate is selected, by selecting an Entered Values: Approximate Value: Option, any entered number's Approximate Value can be determined either independently as determined by the calculation, or else automatically centered between the approximate number's Minimum and Maximum Values so that the +/−Variability Values are equal.

On our calculator when Numbers: Approximate is selected, by selecting various Entered Values: /|Approximate Value|: Options, any entered number can be determined as various combinations of values, (values/|Approximate Value|), ((values/|Approximate Value|)×100%), a value(s) and (values/Approximate Value|), or a value(s) and ((values/|Approximate Value|)×100%).

Sample Calculations

The following sample calculations will demonstrate the use of certain of the above mentioned options available on our calculator.

e.g.: Assume a user wants to calculate the resultant of:
(6+/−1)−3×(12+/−0.5)=

On our calculator when Numbers: Approximate and Values: Show Options are selected, and otherwise default options are selected, this is what could be done:

Click in the Approximate Value real part and then click or type [6]. Click in or tab to the +Variability Value real part and then click or type [1]. Then click or type [−]. In the Approximate Value real part click or type [3]. Then click [symbol] or type [E]. Then click or type [x]. Then click the option Unentered Values: Lone Approximate Value Implies +/−Variability Values: =0.5× Select Approximate Value Decimal Place to select it. Then in the Approximate Value real part click or type [1] then [2]. Then, being careful to leave the approximate symbol cut-off cursor | immediately right of the ones decimal place in the Approximate Value 12, click [symbol] or type [E]. Finally, click or type [=].

Following inserting only two mutually independent unentered values of the approximate first number, the Approximate Value 6 and the +Variability Value 1, in any order, then upon typing [−], the calculator would automatically determine the number with its Approximate Value centered halfway between the Minimum and Maximum Values, with the +/−Variability Values equal, so that the calculator would display the entered approximate first number's five values.

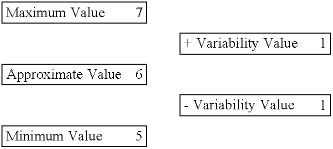

Following inserting only one independent unentered value of the second number, the Approximate Value 3, with the default option Unentered Values: Lone Approximate Value Implies +/−Variability Values: =0 selected, then upon optionally typing [E], the calculator would automatically determine the number with its Minimum, Approximate and Maximum Values all being equal, and with equal +/−Variability Values of 0, implying that the second number is exact, and would display the entered exact second number's five values.

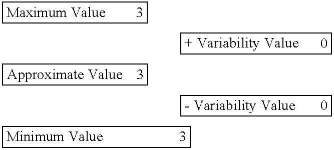

Following typing [x] the calculator would subtract the two five value numbers, then display the entered approximate intermediate resultant number's five values.

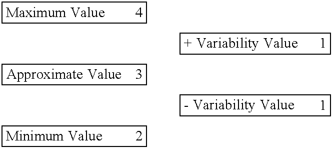

Following both selecting the option Unentered Values: Lone Approximate Value Implies +/−Variability Values: =0.5× Select Approximate Value Decimal Place, and in the Approximate Value inserting 12, in any order, the approximate symbol cut-off cursor | would already happen to be appropriately positioned in the Approximate Value's real part immediately right of the ones decimal place, so that the calculator would automatically assume that the +/−Variability Values=0.5×1=0.5, so that upon typing [E] the calculator would display that entered approximate number's five values.

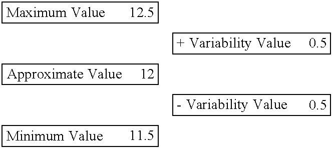

Following typing [=], the calculator would multiply the two prior five value numbers, then display the entered approximate resultant number's five values, completing the calculation.

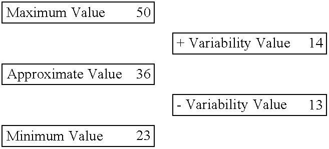

e.g. Assume a user simply wants to determine the five values of the approximate number 360+/−(5% of 360)

On our calculator, when Numbers: Approximate and Values: Show Options are selected, and otherwise default options are selected, this is what could be done:

Select Unentered Values: /|Approximate Value|: +/−Variability Values Only, and Unentered Values: /|Approximate Value|: %, and in the Approximate Value real part insert 360, and in, say, the ((−Variability Value/|Approximate Value|)×100%) real part insert 5. Then upon clicking [symbol] or typing [E], the calculator would assume that the inserted (−Variability Value/|Approximate Value|)×100% is 5% of the Approximate Value 360, and because only two values had been inserted would also assume that the +/−Variability Values are equal, and would therefore display the entered approximate number's five values according to the unchanged default Entered Values: Options selected.

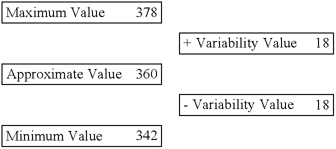

e.g. Assume a user wants to convert the above entered number's values, except for the Approximate Value, to their equivalent percents out of the |Approximate Value|.

Continuing from the above example, select Entered Values: /|Approximate Value|: All Values Except Approximate Value, and then select Entered Values: /|Approximate Value|: %. If the order chosen by the user was to first select Entered Values: /|Approximate Value|: All Values Except Approximate Value, the calculator would first redisplay the above entered approximate number's five values as an Approximate Value, and four other value(s)/|Approximate Value|, as follows.

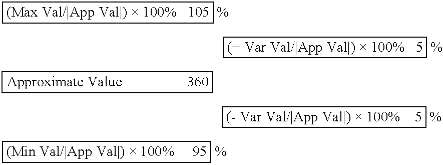

If the order chosen by the user was to next select Entered Values: /|Approximate Value|: %, the calculator would finally redisplay the entered approximate number's five values as an Approximate Value, and four other (value(s)/|Approximate Value|×100%), as follows.

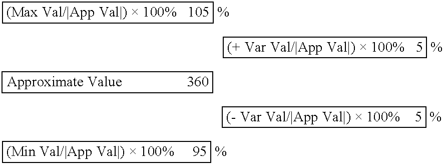

e.g. Assume a user wants to completely determine the five values of an approximate number having a Maximum Value 987.6543, a +Variability Value 0.0003, and a −Variability Value 0.004, and then display the approximate number rounded first to two digits, then display the approximate number rounded instead to the tenths decimal place.

When Numbers: Approximate and Values: Show Options, and otherwise default options are selected, including Entered Values: Simplifying: Round, this is what could be done:

In the Maximum Value insert 987.6543, and in the +Variability Value insert 0.0003, and in the −Variability Value insert 0.004, in any order, as unentered values. Then type [E]. The calculator would then display the entered approximate number's five values according to the default Entered Values: Options selected.

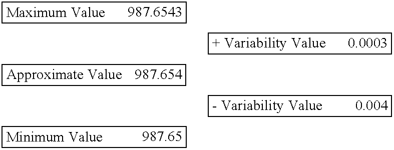

Click the option Entered Values: Simplifying: 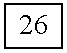
Digits to select it, and replace the 26 perhaps by selecting it and then typing 2. Then click the option Entered Values: Simplifying: 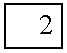
Digits to reselect it. The calculator would then redisplay the above entered approximate number with each value rounded to two digits.

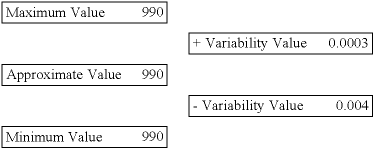

Note that in this rounded number, the Approximate Value, Maximum Value and Minimum Value all happen to be equal, with their two digits being the two 9's, and their 0 being a necessary placeholding 0. Also note that the +Variability Value has two digits beginning with the 3, but only one, the 3, is shown, which should be followed by a 0, but is not since that 0 is not a necessary placeholding 0. Similarly, the −Variability Value has two digits beginning with the 4, which should be followed by a 0, but is not since that 0 is also not a necessary placeholding 0.

After next: either: clicking the option Entered Values: Simplifying:

$$\begin{matrix} & • \\ 10 & \end{matrix}$$

Decimal Place to select it, typing −1, and then again clicking the option Entered Values: Simplifying: 10⁻¹ Decimal Place to select it; or else clicking the option Entered Values: Simplifying: Select Decimal Place to select it, in any value's real part positioning | immediately right of the tenths decimal place, and then again clicking the option Entered Values: Simplifying: Select Decimal Place to select it, the calculator would redisplay that number instead with each value rounded value to the nearest tenth.

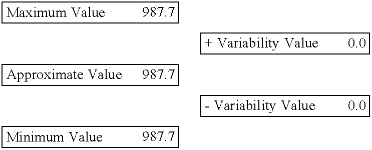

Regardless of which of the two Entered Values: Simplifying: Decimal Place: Options was selected, following either successful rounding by decimal place, the calculator will automatically select the option Entered Values: Simplifying: 10⁻¹ Decimal Place.

Note that in this particular rounded number, the Approximate Value, Maximum Value and Minimum Value all happen to equal to 987.7, and the +/−Variability Values happen to equal 0.0, so that this particular approximate number rounded to this particular precision happens to appear to be an exact number.

e.g. The total variability value of an approximate number is the sum of the +/−variability values of that approximate number, which also equals the difference between the maximum and minimum values of that approximate number. Like the +/−variability values of any approximate number, the total variability value of any approximate number will always be a +value. Either of the following formulas can be used to determine an approximate number's total variability value:
total variability value=(+variability value)+(−variability value)
total variability value=maximum value−minimum value
Assume a user wants to calculate the total variability value of the approximate number

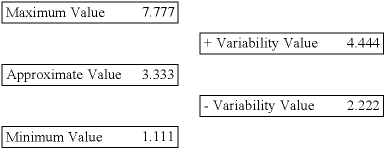

Using the above first formula for the total variability value of the above approximate number implies
total variability value=4.444+2.222
total variability value=6.666

On our calculator, to immediately determine the total variability value of any five value number, subtract that five value number from itself, which is accomplished most simply by typing [−], then [=]. Typing [−], then [=] to subtract the above approximate number from itself results in a new five value number

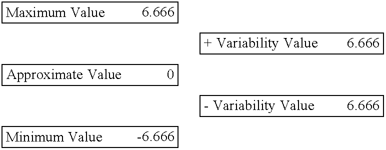

Note that within this new five value number the original five value number's total variability value 6.666 is now displayed three times. Thus, on our calculator, when using the above subtract-it-from-itself technique to determine a five value number's total variability value, a user can use the new number's Maximum Value or either of its +/−Variability Values as being equal to the original five value number's total variability value.

Note that in using the above technique to determine the total variability value of any five value number, the original five value number is lost. Using our calculator, there is also a further technique for determining the total variability value of any five value number while saving that five value number for possible further use. First type [M] to memorize the original five value number, then type [−], then [=], then perhaps use the new number's Maximum Value as the original number's desired total variability value. Finally, type [PM] to reinsert the original five value number, ready for further use.

Specifications

This calculator is limited to operate upon numbers composed of values such that each value has a magnitude in the range:
1×10⁻³⁰⁰ to 1×10³⁰⁰, and 0

Options and screen buttons are each background color coded either unentered color, entered color, or neutral color, so that when Customize: Entered Color: On is selected, a user will know if successful use of a an option or screen button will end displaying an unentered number, or an entered number, or not affect whether a number is unentered or entered.

When Numbers: Exact is selected, this calculator uses an exact symbol [symbol] which represents each one value number as it might appear on a graph. The one black square represents the one value number's one Exact Value point.

When Numbers: Approximate is selected, this calculator replaces the use of the approximate symbol [symbol] with the use of the new approximate symbol [symbol] which represents each five value number as it might appear on a graph. The top, middle and bottom black squares respectively represent the five value number's Maximum Value, Approximate Value and Minimum Value points. The upper gray rectangle represents the five value number's +Variability Value, which is the largest possible additive error when using the five value number's Approximate Value to represent it, and which equals the difference between its Maximum Value and its Approximate Value. The lower gray rectangle represents the five value number's—Variability Value, which is the largest possible subtractive error when using the five value number's Approximate Value to represent it, and which equals the difference between its Approximate Value and its Minimum Value.

When Numbers: Approximate is selected, this calculator replaces the use of the approximate symbol [symbol] (=overbar) with the use of the new approximate symbol | which is just a simplified version of the above new approximate symbol [symbol] and which is more easily useable in both typing and writing.

The keyboard arrow keys can be used to reposition the cursor within any editable part of any value of any number, and can be useful for counting digits, either to determine the number of digits in a value, or to determine the decimal place of a digit in a value.

When not using a mouse:

To activate:
[−1 x] type [Shift] [−]
[CL] type [Backspace]
[CE] type [c]
[CA] type [Shift] [c]

To select a menu item: Continually hold down [Alt] while typing the character shown underlined in the desired menu the item is in, then, if any, the character shown underlined in the submenu the item is in, etc., until typing the character shown underlined in the item itself.

To reposition the cursor from one editable number part into another editable number part:

Type [Tab] or [Shift] [Tab]. When Numbers: Approximate is selected, and only unentered values have been typed, to avoid [Tab] stoppages at dependent values, we recommend typing in the Approximate Value last.

Note [Tab] will not reposition the cursor to any menu item, or [−1 x], [.], [0], [1], . . . , or [9], or any Unentered Values: or Entered Values: buttons, options, text boxes or checkboxes.

[PM] and [π] both supersede Unentered Values: Auto Paste: [On].

[M] and Unentered Values: Auto Paste: [M] will memorize a number's value(s) as follows: they will memorize each value's real part only if it is numeric, and only then its integer exponent of base 10 part if it is numeric.

Both [M] and [PM], and Unentered Values: Auto Paste: [M] and [On], will memorize and paste copies of an unentered number's value(s) as typed, to be interpreted upon entry according to the Unentered Values: Options then selected. With entered numbers, [M] memorizes only an entered number's fundamental value(s) and subsequently [PM] simultaneously enters a copy of the entered number's fundamental value(s) into the current calculation and displays that entered number's value(s) subject to the Entered Values: Options selected.

When Numbers: Approximate is selected, and Unentered Values: Auto Paste: [On] is selected, we recommend a user type a new number's first character ([−1 x], [.], or [0], [1], . . . , or [9]) into a number part which will not be a part of a dependent value once Unentered Values: Auto Paste: [On] pasting has occurred.

To automatically paste an unentered number's value(s) from Unentered Values: Auto Paste: [M] without effectively changing any value, a user can cause Unentered Values: Auto Paste: [On] to paste by typing the decimal [.] as a new number's first character, which will not effectively change any Unentered Values: Auto Paste: [On] pasted value.

To stop automatic pasting for any new number when Unentered Values: Auto Paste: [On] is selected, select Unentered Values: Auto Paste: [Off] prior to typing the new number's first character. When automatic pasting is again desired, then prior to typing the next new number's first character select Unentered Values: Auto Paste: [On].

When necessary, this calculator displays dialog boxes to guide the user to type:
enough values to completely determine a number;
only values which are within the set limits of this calculator;
and when Numbers: Approximate is selected:
only values such that all values are mutually independent;
only values such that the: Maximum Value>=Approximate Value>=Minimum Value.

Dialogue boxes displayed in similar situations may vary according to the options selected.

On this calculator, “fundamental values” are internally stored entered numbers' values which are unrounded, in scientific notation having their real parts truncated to 28 digits and their integer exponent of base 10 parts up to 3 digits, and when Numbers: Approximate is selected, assuming independent +/−Variability Values, and values as is i.e. no (values/|Approximate Value|).

On this calculator, “actual values” are fundamental values, with the exception that when Parts: Real is selected, actual values are in real notation, not in scientific notation.

An entered, including resultant, number's fundamental value(s) continue to remain stored and ready for use even after having been just used to determine that entered number's representation according to the current combination of Entered Values: Options selected. To redisplay the entered number according to some other combination of Entered Values: Options, simply select that other combination of options. As each new Entered Value: Option is selected, our calculator redetermines that entered number's representation according to the current combination of Entered Values: Options, always beginning from the stored fundamental value(s). To perform further mathematical operations upon an entered number already displayed according to any combination of Entered Values: Options, simply continue the calculation by typing the appropriate next operator. Regardless of the combination of Entered Values: Options selected, the further mathematical operation will be done upon those entered numbers' fundamental values, producing a further resultant number also having a stored fundamental value(s). A resultant number's stored fundamental value(s) will then remain stored internally even after also having just been used to determine the resultant value(s) displayed according to the combination of Entered Values: Options then selected.

When Numbers: Exact is selected, the screen enter button [E] appears as [symbol] immediately adjacent to the Exact Value, graphically representing each exact number's one value.

When Numbers: Approximate is selected, the screen enter button [E] appears as [symbol] among a number's five values, graphically representing each approximate number's five values, with each of the five values adjacent to the part of the symbol representing it.

When entering the first number in any new calculation, [=] can be typed in place of [E].

On this calculator, [E] and the various Entered Values: Options can be used simply to completely determine, convert and/or simplify exact and approximate numbers, without necessarily doing any mathematical operations upon those numbers.

When | is positioned in a value's real part next to a digit, it can be used to select the decimal place immediately to its left, indicating a continuous range of possible values within +/−0.5× (the product of that value's real part's selected decimal place multiplied by that value's power of 10, if any). On this calculator this selected continuous range of possible values can be used for any of three purposes, as follows:

To Determine +/−Variability Values:

When an unentered Approximate Value only has been typed, and Unentered Values: Lone Approximate Value Implies +/−Variability Values: =0.5× Select Approximate Value Decimal Place is selected, and the user has positioned | in the Approximate Value's real part next to a digit causing the selected decimal place to be the decimal place immediately to its left, then upon entry, | automatically determines that approximate number's +/−Variability Values.

To Determine Rounding:

When a number has already been entered, and Entered Values: Simplifying: Select Decimal Place has just been selected, and the user has positioned | in any one value's real part next to a digit causing the selected decimal place to be the decimal place immediately to its left, then upon clicking Entered Values: Simplifying: Select Decimal Place, | automatically determines the new rounding or truncating decimal place of the entered number's value(s).

To Indicate Rounding:

When a number has already been both entered, and rounded according to a selected Entered Values: Simplifying: Decimal Place option, then each time any one value's real part is non-repetitively clicked in, | automatically self-positions such that immediately to its left is that value's rounding or truncating decimal place.

When rounding, this calculator rounds differently for different values when the rounding decimal place is followed by the digit 5, and only zeros, or nothing, follow the 5:

If the rounding decimal place digit is even, or non-existent, the calculator rounds down,

e.g.: 6.50 rounded in the ones decimal place rounds down to 6.

else, if the rounding decimal place digit is odd, the calculator rounds up.

e.g.: 7.50 rounded in the ones decimal place rounds up to 8.

This rounding method tends to equalize rounding up and rounding down for large groups of rounded values, and thus tends to avoid introducing any bias by rounding.

When no Entered Values: Simplifying: Digits or Decimal Place option has been properly specified this calculator automatically defaults to Entered Values: Simplifying: 26 Digits, which rounds or truncates each entered, including resultant, number's value's real part from its internal 28 digits to 26 digits.

On this calculator, “automatically reselecting for (all) actual entered value(s)” means the following Options will be selected:
Entered Values: Simplifying: Truncate;
Entered Values: Simplifying: None: 28 Digits;
and if Parts: Real is selected,
   Entered Values: Notation: Real;
or if Parts: Real×10 Exp is selected,
   Entered Values: Notation: Scientific;
and if Numbers: Approximate is selected,
   Values Visible: All;
   and Entered Values: Approximate Value: Independent;
   and Entered Values: /|Approximate Value|: No Values.

This calculator simplifies entered numbers' values subject to all the Entered Values: Options selected, and so is not necessarily simplifying numbers' original unentered typed values.

Users may be familiar with simplifying exact numbers on a standard calculator. We recommend that a user keep in mind that it is possible to simplify too much. Simplifying an approximate number introduces extra +/−variabilities into each value of that approximate number. When Numbers: Approximate is selected and a user is simplifying an entered number's values, it is possible, but perhaps not desirable, to simplify a five value number's values to a decimal place such that each individual value's extra +/−variabilities introduced by simplifying can approach or exceed one or both of the number's unsimplified +/−Variability Values.

When Parts: Real×10 Exp is selected, and an Entered Values: /|Approximate Value|: Option, except for No Values, is selected, each (value/|Approximate Value|) in a number is converted to a real×10⁰, superseding all Entered Values: Notation: Options.

This calculator completes mathematical operations as typed, and does not reorder them according to the order of mathematical operations.

Since various modifications can be made in our invention as herein above described, and many apparently widely different embodiments of same made within the spirit and scope of the claims without departure from such spirit and scope, it is intended that all matter contained in the accompanying specification shall be interpreted as illustrative only and not in a limiting sense.

1. Apparatus comprising:
a processor;
an input element which is operable by a user to input numerical values and symbols into the processor;
a display operated by the processor for displaying the numerical values and the symbols;
wherein the processor is programmed to receive input of the values and the symbols, and to display using the values and the symbols, a plurality of approximate numbers including for each certain values which determine that approximate number;
and wherein the processor is programmed to carry out calculations using the plurality of approximate numbers to generate resultant approximate numbers which are each determined by resultant values which are determined by the calculation.

2. The apparatus according to claim 1 wherein the processor is programmed to correctly determine the resultant approximate numbers by mathematically operating directly upon the input approximate numbers, not by estimation using rules for estimating resultant accuracy or precision.

3. The apparatus according to claim 1 wherein the processor is programmed to input and display approximate numbers each composed of up to six values, with the six values consisting of an approximate value, a maximum value, a minimum value, an additive variability value, a subtractive variability value and a total variability value.

4. The apparatus according to claim 1 wherein the processor is programmed to receive input of the values and the symbols, and to display using the values and the symbols, a plurality of approximate numbers and exact numbers, including for each number certain values which determine that number.

5. The apparatus according to claim 4 wherein the processor is programmed to carry out calculations using both the approximate numbers and the exact numbers to correctly generate resultant numbers, and to determine the resultant numbers by mathematically operating directly upon the input approximate numbers and exact numbers, not by estimation using rules for estimating resultant accuracy or precision.

6. The apparatus according to claim 4 wherein the processor is programmed to input and display approximate and exact numbers each composed of up to six values, with the six values consisting of an approximate value, a maximum value, a minimum value, an additive variability value, a subtractive variability value and a total variability value.

7. The apparatus according to claim 1 wherein the processor is programmed to input and display exact numbers each composed of one value.

8. The apparatus according to claim 7 wherein the processor is programmed to carry out calculations using the plurality of exact numbers to determine the resultant numbers by mathematically operating directly upon the input exact numbers.

9. The apparatus according to claim 1 wherein the processor, the input element and the display are arranged to incorporate two new, more graphically correct approximate symbols: [symbol] and |, to replace the commonly used approximate symbols: [symbol] and [symbol] (overbar).

10. The apparatus according to claim 7 wherein the processor, the input element and the display are arranged to incorporate a new, graphically correct exact symbol:

[symbol]

11. The apparatus according to claim 3 wherein the processor, the input element and the display are arranged such that each number's value(s) is symbolically represented, where [symbol] represents each up-to-six value number and [symbol] represents each one value number.

12. The apparatus according to claim 1 wherein the processor, the input element and the display are arranged such that each value of each number is displayed graphically arranged adjacent to the part of the symbol representing it.

13. The apparatus according to claim 3 wherein the processor, the input element and the display are arranged such that no more than three mutually independent input values are required to determine all values of each up-to-six value number.

14. The apparatus according to claim 3 wherein the processor, the input element and the display are arranged such that no more than two mutually independent input values are required to determine all values of each up-to-six value number when the numbers have equal additive and subtractive variability values.

15. The apparatus according to claim 3 wherein the processor, the input element and the display are arranged such that only one input value is required to determine all values of an up-to-six value number by selecting input option additive and subtractive variability values +/−0 for exact numbers, or input option additive and subtractive variability values +/−0.5 of the decimal place determined by the positioning of a symbol in the approximate value's real part.

16. The apparatus according to claim 1 wherein the processor, the input element and the display are arranged such that the options Parts: Real, and Parts: Real×10 Exp, replace a standard calculator's Mode: Normal, and [EE] (or [EXP]) buttons.

17. The apparatus according to claim 1 wherein the processor, the input element and the display are arranged so as to display values in visually proper real, or real×10^{exponent}, mathematical notation.

18. The apparatus according to claim 1 wherein the processor, the input element and the display are arranged so as to provide an automatic pasting option which can cause an editable input value(s) or character(s) to be automatically pasted whenever a new number's first character is typed.

19. The apparatus according to claim 1 wherein the processor, the input element and the display are arranged to determine and convert a number among simplifying options including rounding or truncating, either fixed or with placeholding zeros only, either by typing the desired number of digits, or by typing the integer exponent of base 10 of a desired decimal place, or by positioning a symbol immediately right of a desired digit or decimal place.

20. The apparatus according to claim 1 wherein the processor, the input element and the display are arranged such that when first positioned within a number's value's real part, a symbol automatically self-positions at 0 digits to aid in counting digits if simplifying by digits, or the symbol automatically self-positions immediately right of the desired decimal place indicating the desired decimal place if simplifying by decimal place.

21. The apparatus according to claim 1 wherein the processor, the input element and the display are arranged such that a number can be determined and converted among a plurality of mathematical notations, including scientific, engineering and real×(a desired power of 10).

22. The apparatus according to claim 1 wherein the processor, the input element and the display are arranged such that a number can be determined and converted among having an approximate value generated directly by calculation, or having an approximate value centered between minimum and maximum values of the number.

23. The apparatus according to claim 1 wherein the processor, the input element and the display are arranged so as to determine and convert a number among a plurality of combinations of input and output values including values, (values/|approximate value|) and ((values/|approximate value|)×100%).
